(19) United States
(12) Patent Application Publication
(10) Pub. No.: US 2009/0208190 A1
(43) Pub. Date: Aug. 20, 2009

(54) INFORMATION REPRODUCING APPARATUS AND METHOD, MANAGING APPARATUS AND METHOD, INFORMATION REPRODUCING SYSTEM, AND COMPUTER PROGRAM

(75) Inventors: Nobuyuki Takakuwa, Saitama (JP); Yasuko Fukuda, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/300,038

(22) PCT Filed: May 18, 2007
(86) PCT No.: PCT/JP2007/060274

§ 371 Date: Nov. 7, 2008

(30) Foreign Application Priority Data
May 18, 2006 (JP) 2006-138719

(51) Int. Cl. H04N 5/00

(52) U.S. Cl. 386/126

(57) ABSTRACT

A reproducing apparatus (100) is provided with: a first reading device (112) for reading main content recorded on a first recording medium; a second reading device (121, 123, 125) for reading additional content which is to be reproduced with the main content from a plurality of second recording media (122, 124, 126) on each of which the additional content is recorded; a notifying device (113b, 116) for notifying a managing apparatus (20) which manages the main content and the additional content of notice information which indicates the main content and the additional content; and a reproducing device (115) for reproducing the main content and the additional content.

### TECHNICAL FIELD

The present invention relates to an information reproducing apparatus and method, such as a Blu-ray Disc player, a managing apparatus, such as a management server, for managing content information which is reproduced by the information reproducing apparatus, an information reproducing system provided with the information reproducing apparatus and the managing apparatus, and a computer program which makes a computer function as the information reproducing apparatus or the managing apparatus.

### BACKGROUND ART

A DVD is generalized as an optical disc on which various information, such as reproduction control information and content information like a video (main picture), an audio, and a sub-picture. According to a DVD standard, each of video information (video data), audio information (audio data), and sub-picture information (sub-picture data) as well as the reproduction control information (navigation data) is packetized, multiplexed and recorded on a disc in a program stream format of MPEG 2 (Moving Picture Experts Group phase 2), which is a highly-efficient coding technology. Of them, the video information has one stream of data compressed in accordance with a MPEG video format (ISO 13818-2), in one program stream. On the other hand, the audio information is recorded in a plurality of methods (i.e. linear PCM, AC-3, MPEG audio, and the like), and there can be up to 8 streams in total in one program stream. The sub-picture information is defined in bitmap and is compressed and recorded in a run length method, and there can be up to 32 streams in one program stream. As described above, in case of the DVD, by adopting the program stream format, a plurality of streams of audio information which can be selected (e.g. streams of stereo sound, or surround sound, original English audio, Japanese dubbed audio, and the like), and a plurality of streams of sub-picture information which can be selected (e.g. streams of Japanese subtitles, English subtitles, and the like) are multiplexed and recorded for one stream of video information, for example in one movie.

On the other hand, the transport stream format of the MPEG 2 standard has been recently standardized, and this is suitable for larger-capacity or higher-speed data transmission. According to the transport stream format, compared to the aforementioned program stream format, a plurality of elementary streams are simultaneously transmitted at a far higher transmission rate. For example, a plurality of shows or programs, such as a number of satellite digital broadcast TV channels, are time-division multiplexed and are simultaneously transmitted in one satellite radio wave. That is, in the transport stream format, it is possible to time-division multiplex and simultaneously transmit a plurality of elementary streams of video, each of which has a large data amount. For example, it is possible to simultaneously transmit a plurality of movies which are recorded on a plurality of DVDs. The transport stream is used in a Blu-ray Disc (hereinafter referred to as a “BD”, as occasion demands), for example.

In such an optical disc, such a reproducing method has been developed that the audio information and the sub-picture information corresponding to the video information which is recorded on the optical disc are recorded in a local storage such as a SD card, a memory stick, a hard disk or the like, and that the local storage is combined with the optical disc as occasion demands, to thereby reproduce the content information. For example, it is assumed that a movie including an English audio, a Japanese audio, English subtitles, and Japanese subtitles is recorded on the optical disc and that a French audio and French subtitles or the like corresponding to the movie are recorded in the local storage. In this case, by combining the optical disc with the local storage, the movie can be reproduced with the French audio or the French subtitles, instead of the English audio, the Japanese audio, the English subtitles, and the Japanese subtitles. In the reproduction performed by combining the optical disc with the local storage, a directory hierarchy of the content information including the video information, the audio information, and the sub-picture information or the like recorded on the optical disc and a directory hierarchy of the content information including the video information, the audio information, and the sub-picture information or the like recorded in the local storage are reconstructed as a directory hierarchy of one virtual file system. Then, for example, when an information reproducing apparatus, such as a BD player, reproduces the content information, the content information is reproduced by referring the virtual file system.

### DISCLOSURE OF INVENTION

### Subject to be Solved by the Invention

However, in the aforementioned virtual file system, usually, only the case where one optical disc and one local storage are combined is assumed. Thus, there is such a technical problem that for example, one optical disc and a plurality of local storage cannot be combined.

In view of the conventional problems described above, it is therefore an object of the present invention to provide an information reproducing apparatus and method, a managing apparatus and method, and an information reproducing system, which allow preferable reproduction of the content information recorded on a plurality of information recording media, such as local storages, and the content information recorded on an information recording medium, such as an optical disc, and a computer program which makes a computer function as the information reproducing apparatus and the managing apparatus.

### MEANS FOR SOLVING THE SUBJECT

### Information Reproducing Apparatus

The above object of the present invention can be achieved by an information reproducing apparatus provided with: a first reading device for reading main content information which is recorded on a first information recording medium; a second reading device for reading additional content information which is to be reproduced with the main content information from a plurality of second information recording media on each of which the additional content information is recorded; a notifying device for notifying a managing apparatus which manages the main content information and the additional content information of notice information which indicates the main content information and the additional content information; and a reproducing device for reproducing the main content information and the additional content information.

According to the information reproducing apparatus of the present invention, by the operation of the first reading device, the main content information which is recorded on the first information recording medium is read. Moreover, by the operation of the second reading device, the additional content information which is recorded on the second information recording medium is read. The main content information is for example content information which indicates video images of a movie. The additional content information is content information which is to be reproduced with the main content information and which indicates for example audio and subtitles of a movie. Moreover, by the operation of the reproducing device, the main content information and the additional content information are reproduced. By this, the content information, such as a movie including desired audio and desired subtitles, is reproduced.

In particular, in the present invention, by the operation of the notifying device, the managing apparatus is notified of the notice information. The notice information indicates the main content information recorded on the first information recording medium and the additional content information recorded on the second information recording medium (e.g. information which identifies the main content information and the additional content information, information which indicates the types of the main content information and the additional content information, information which indicates a combination or structure of the main content information and the additional content information, and the like). Moreover, the managing apparatus manages the main content information and the additional content information and is used by e.g. an author who prepares the main content information and the additional content information to manage the main content information and the additional content information.

By this, for example, as detailed later, it is possible to integrate the main content information and the additional content information, on the basis of integrated information for integrating the main content information, which is recorded on the first information recording medium, and the plurality of additional content information, each of which is recorded on respective one of the plurality of second information recording media, wherein the integrated information is generated by the managing apparatus notified of the notice information. Here, the term “integrate” in the present invention indicates that the main content information and the additional content information are logically recognized as one directory hierarchy, and more specifically, for example, it indicates in effect generating a virtual file system described later. Thus, even if the additional content information is read from the plurality of second information recording media, it is possible to preferably reproduce the plurality of additional content information each of which is recorded on respective one of the plurality of second information recording media, together with the main content information which is recorded on the first information recording medium, by notifying the managing apparatus of the notice information.

In addition, by the operation of the notifying device, the notice information is given without a user's help of the information reproducing apparatus. Thus, according to the present invention, in order to preferably reproduce the additional content information with the main content information (in other words, in order to integrate the additional content information and the main content information), it is unnecessary to make a user select the desired additional content information from the plurality of additional content information each of which is recorded on respective one of the plurality of second information recording media. Moreover, even the additional content information that is not selected by the user can be preferably reproduced as occasion demands, without integrating the main content information and the additional content information again.

In one aspect of the information reproducing apparatus of the present invention, it is further provided with: an integrated information obtaining device for obtaining integrated information which is transmitted from the managing apparatus that is notified of the notice information and which is to integrate the main content information and the additional content information; and an integrating device for integrating the main content information and the additional content information by using the integrated information obtained by the integrated information obtaining device, the reproducing device reproducing the main content information and the additional content information that are integrated.

According to this aspect, the plurality of additional content information, each of which is recorded on respective one of the plurality of second information recording media, and the main content information, which is recorded on the first information recording medium, are integrated on the basis of the integrated information. The integrated information is used by the information reproducing apparatus in order to integrate the additional content information which is recorded on the plurality of second information recording media and the main content information which is recorded on one first information recording medium. More specifically, for example, the integrated information is necessary to constitute a virtual file system described later, which is generated on the basis of the additional content information which is recorded on the plurality of second information recording media and the main content information which is recorded on one first information recording medium.

By this, as compared to the aforementioned background which normally integrates only the additional content information which is recorded on one second information recording medium and the main content information which is recorded on one first information recording medium, it is possible to receive such a great advantage that the plurality of additional content information each of which is recorded on respective one of the plurality of second information recording media and the main content information which is recorded on the one first information recording medium can be preferably integrated.

In an aspect of the information reproducing apparatus provided with the integrating device as described above, the integrating device may integrate the main content information and the additional content information by generating file system information which is to integrate and manage the main content information and the additional content information, and the reproducing device may reproduce the main content information and the additional content information on the basis of the file system information.

By virtue of such construction, it is possible to preferably reproduce the plurality of additional content information each of which is recorded on respective one of the plurality of second information recording media and the main content information which is recorded on the one first information recording medium, on the basis of the file system information (e.g. virtual file system described later).

In an aspect of the information reproducing apparatus provided with the integrating device as described above, it may be further provided with a recording device for recording configuration information, which indicates a structure of the main content information and the additional content information that are integrated, onto at least one of the plurality of second information recording media.

By virtue of such construction, once the main content information and the additional content information are integrated, the configuration information which indicates the structure or configuration of the integration can be recorded onto at least one of the second information recording media. Thus, if the main content information and the additional content information which are to be integrated are the same as the main content information and the additional content information whose structure is indicated by the configuration information, it is possible to integrate again the main content information and the additional content information, relatively easily, with reference to the configuration information recorded on at least one of the second information recording media.

In an aspect of the information reproducing apparatus provided with the recording device as described above, if the configuration information is recorded on at least one of the plurality of second information recording media and if the additional content information, which is to be read by the second reading device, is the same as the additional content information included in the main content information and the additional content information that are integrated, whose structure is indicated by the configuration information, the notifying device does not have to notify the managing apparatus of the notice information, and the integrating device may integrate the main content information and the additional content information by using the configuration information.

By virtue of such construction, once the main content information and the additional content information are integrated, the configuration information which indicates the structure or configuration of the integration can be recorded onto at least one of the second information recording media. Thus, if the main content information and the additional content information which are to be integrated are the same as the main content information and the additional content information whose structure is indicated by the configuration information, it is possible to integrate again the main content information and the additional content information, relatively easily, with reference to the configuration information recorded on at least one of the second information recording media. That is, since it is unnecessary to notify again the managing apparatus of the notice information and it is unnecessary to obtain again the integrated information from the managing apparatus, it is possible to relatively reduce a processing load of the information reproducing apparatus.

In another aspect of the information reproducing apparatus of the present invention, it is further provided with a file system information generating device for generating provisional file system information by prioritizing the additional content information and registering the additional content information in the order of descending priorities in file system information which is to integrate and manage the main content information and the additional content information, the reproducing device starting the reproduction of the main content information and the additional content information on the basis of the provisional file system information, the notifying device notifying the managing apparatus of the reproduction based on the provisional file system information as the notice information.

According to this aspect, even if the plurality of additional content information are recorded on the plurality of second information recording media, the provisional file system information can be generated by prioritizing the additional content information. In other words, it is possible to provisionally or temporarily integrate the plurality of second additional content information each of which is recorded on respective one of the plurality of second information recording media and the main information which is recorded on the one first information recording medium. Then, the managing apparatus can be notified of the reproduction based on the generated provisional file system information, as the notice information. Then, by using the integrated information obtained as a result, it is possible to correctly integrate the plurality of additional content information each of which is recorded on respective one of the plurality of second information recording media and the main information which is recorded on the one first information recording medium.

This aspect is particularly effective in a BD in which the operation of the information reproducing apparatus solo is independent of the operation by e.g. a Java application executed on the information reproducing apparatus. Specifically, in the BD, for example, the reading and the recording of the additional content information on the second information recording medium are performed by the Java application, and the reading of the additional content information on the second information recording medium and the generation of the file system information are performed by the information reproducing apparatus. In this case, by once generating the provisional file system information, as described above, it is possible to notify the Java application of the fact that the main content information and the additional content information cannot be preferably integrated, from the information reproducing apparatus. As a result, the Java application can obtain the integrated information from the managing apparatus.

In another aspect of the information reproducing apparatus of the present invention, the additional content information is recorded on the first information recording medium in addition to the main content information, and the first reading device reads the additional content information recorded on the first information recording medium.

According to this aspect, it is possible to preferably reproduce the plurality of additional content information each of which is recorded on respective one of the plurality of second information recording media and the additional content information which is recorded on the first information recording medium, with the main content information which is recorded on the first information recording medium.

Incidentally, if the additional content information is recorded on the first information recording medium, the notifying device notifies the managing apparatus of the notice information which indicates the additional content information which are recorded on the first information recording medium and the second information recording media. In this case, the integrated information is referred to by the information reproducing apparatus in order to integrate the additional content information which are recorded on the first information recording medium and the plurality of second information recording media and the main content information which is recorded on the one first information recording medium.

(Information Reproducing Method)

The above object of the present invention can be also achieved by an information reproducing method provided with: a first reading process of reading main content information which is recorded on a first information recording medium; a second reading process of reading additional content information which is to be reproduced with the main content information from a plurality of second information recording media on each of which the additional content information is recorded; a notifying process of notifying a managing apparatus which manages the main content information and the additional content information of notice information, which indicates the main content information and the additional content information; and a reproducing process of reproducing the main content information and the additional content information.

According to the information reproducing method of the present invention, it is possible to receive the same various benefits as those of the aforementioned information reproducing apparatus of the present invention.

Incidentally, in response to the various aspects of the aforementioned information reproducing apparatus of the present invention, the information reproducing method of the present invention can also adopt various aspects.

(Managing Apparatus)

The above object of the present invention can be also achieved by a managing apparatus for managing main content information, which is recorded on a first information recording medium mounted on an information reproducing apparatus, and additional content information, which is to be reproduced with the main content information and which is recorded on a plurality of second information recording media mounted on the information reproducing apparatus with the first recording medium, the managing apparatus provided with: a notice information recognizing device for recognizing an operation of the information reproducing apparatus which notifies the managing apparatus of notice information which indicates the main content information and the additional content information; and a notice information obtaining device for obtaining the notice information of which the managing apparatus is notified by the information reproducing apparatus.

According to the managing apparatus of the present invention, by the operation of the notice information recognizing device, it is possible to recognize that the information reproducing apparatus is to give the notice information. As a result, by the operation of the notice information obtaining device, the notice information is obtained.

By this, for example, as detailed later, the managing apparatus can generate the integrated information as described later. That is, even if the information reproducing apparatus reads the additional content information from the plurality of second information recording media, the information reproducing apparatus which notifies the managing apparatus of the notice information can preferably reproduce the plurality of additional content information each of which is recorded on respective one of the plurality of second information recording media, with the main content information which is recorded on the first information recording medium, by notifying the managing apparatus of the notice information.

As described above, according to the managing apparatus of the present invention, according to the managing apparatus of the present invention, it is possible to receive the same benefits as those of the information reproducing apparatus of the present invention described above.

In one aspect of the managing apparatus of the present invention, it is further provided with an integrated information generating device for generating integrated information, which is to integrate the main content information and the additional content information, on the basis of the notice information obtained by the notice information obtaining device.

According to this aspect, the information reproducing apparatus can preferably integrate the plurality of additional content information each of which is recorded on respective one of the plurality of second information recording media and the main content information which is recorded on the first information recording medium, on the basis of the integrated information generated by the integrated information generating device.

In an aspect of the managing apparatus provided with the integrated information generating device as described above, it may be further provided with a transmitting device for transmitting the integrated information generated by the integrated information generating device, to the information reproducing apparatus.

According to this aspect, the information reproducing apparatus can preferably integrate the plurality of additional content information each of which is recorded on respective one of the plurality of second information recording media and the main content information which is recorded on the first information recording medium, by obtaining the integrated information transmitted by the transmitting device.

(Managing Method)

The above object of the present invention can be also achieved by a managing method of managing main content information and additional content information in a managing apparatus which manages the main content information, which is recorded on a first information recording medium mounted on an information reproducing apparatus, and the additional content information, which is to be reproduced with the main content information and which is recorded on a plurality of second information recording media mounted on the information reproducing apparatus with the first recording medium, the managing method provided with: a notice information recognizing process of recognizing an operation of the information reproducing apparatus which notifies the managing apparatus of notice information which indicates the main content information and the additional content information; and a notice information obtaining process of obtaining the notice information of which the managing apparatus is notified by the information reproducing apparatus.

According to the managing method of the present invention, it is possible to receive the same various benefits as those of the aforementioned managing apparatus of the present invention.

Incidentally, in response to the various aspects of the aforementioned managing apparatus of the present invention, the managing method of the present invention can also adopt various aspects.

(Information Reproducing System)

The above object of the present invention can be also achieved by an information reproducing system provided with: an information reproducing apparatus (i.e. the aforementioned information reproducing apparatus of the present invention (including its various aspects)); and a managing apparatus (i.e. the aforementioned managing apparatus of the present invention (including its various aspects)), the information reproducing apparatus provided with: a first reading device for reading main content information which is recorded on a first information recording medium; a second reading device for reading additional content information which is to be reproduced with the main content information from a plurality of second information recording media on each of which the additional content information is recorded; a notifying device for notifying of notice information which indicates the main content information and the additional content information; and a reproducing device for reproducing the main content information and the additional content information, the managing apparatus provided with: a notice information recognizing device for recognizing an operation of the information reproducing apparatus which notifies the managing apparatus of the notice information; and a notice information obtaining device for obtaining the notice information of which the managing apparatus is notified by the information reproducing apparatus.

According to the information reproducing system of the present invention, it is possible to receive the same various benefits as those of the aforementioned information reproducing apparatus and managing apparatus of the present invention.

Incidentally, in response to the various aspects of the aforementioned information reproducing apparatus and managing apparatus of the present invention, the information reproducing system of the present invention can also adopt various aspects.

In one aspect of the information reproducing system of the present invention, the managing apparatus is further provided with an integrated information generating device for generating integrated information, which is to integrate the main content information and the additional content information, on the basis of the notice information obtained by the notice information obtaining device, the information reproducing apparatus is further provided with: an integrated information obtaining device for obtaining the integrated information; and an integrating device for integrating the main content information and the additional content information by using the integrated information obtained by the integrated information obtaining device, and the reproducing device reproduces the main content information and the additional content information that are integrated.

According to this aspect, the plurality of additional content information, each of which is recorded on respective one of the plurality of second information recording media, and the main content information, which is recorded on the first information recording medium, are integrated on the basis of the integrated information. By this, as compared to the aforementioned background which normally integrates only the additional content information which is recorded on one second information recording medium and the main content information which is recorded on one first information recording medium, it is possible to receive such a great advantage that the plurality of additional content information each of which is recorded on respective one of the plurality of second information recording media and the main content information which is recorded on the one first information recording medium can be preferably integrated.

(Computer Program)

The above object of the present invention can be also achieved by a first computer program for controlling a computer provided for an information reproducing apparatus (i.e. the aforementioned information reproducing apparatus of the present invention (including its various aspects)) provided with: a first reading device for reading main content information which is recorded on a first information recording medium; a second reading device for reading additional content information which is to be reproduced with the main content information from a plurality of second information recording media on each of which the additional content information is recorded; a notifying device for notifying a managing apparatus which manages the main content information and the additional content information of notice information which indicates the main content information and the additional content information; and a reproducing device for reproducing the main content information and the additional content information, the computer program making the computer function as at least one portion of the first reading device, the second reading device, the notifying device, and the reproducing device.

According to the first computer program of the present invention, the aforementioned information reproducing apparatus of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects of the aforementioned information reproducing apparatus of the present invention, the first computer program of the present invention can adopt various aspects.

The above object of the present invention can be also achieved by a second computer program for controlling a computer provided for a managing apparatus (i.e. the aforementioned managing apparatus of the present invention (including its various aspects)), for managing main content information, which is recorded on a first information recording medium mounted on an information reproducing apparatus, and additional content information, which is to be reproduced with the main content information and which is recorded on a plurality of second information recording media mounted on the information reproducing apparatus with the first recording medium, the managing apparatus comprising: a notice information recognizing device for recognizing an operation of the information reproducing apparatus which notifies the managing apparatus of notice information which indicates the main content information and the additional content information; and a notice information obtaining device for obtaining the notice information of which said managing apparatus is notified by the information reproducing apparatus, the computer program making the computer function as at least one portion of the notice information recognizing device and the notice information obtaining device.

According to the second computer program of the present invention, the aforementioned managing apparatus of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects of the aforementioned managing apparatus of the present invention, the second computer program of the present invention can adopt various aspects.

The above object of the present invention can be also achieved by a first computer program product in a computer-readable medium for tangibly embodying a program of instructions executable by a computer provided for the aforementioned information reproducing apparatus of the present invention (including its various aspects), the computer program product making the computer function as at least one portion of the first reading device, the second reading device, the notifying device, and the reproducing device.

The above object of the present invention can be also achieved by a second computer program product in a computer-readable medium for tangibly embodying a program of instructions executable by a computer provided for the aforementioned managing apparatus of the present invention (including its various aspects), the computer program product making the computer function as at least one portion of the notice information recognizing device and the notice information obtaining device.

According to the first or second computer program product of the present invention, the aforementioned information reproducing apparatus or managing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information reproducing apparatus or managing apparatus of the present invention.

These effects and other advantages of the present invention will become more apparent from the embodiments explained below.

As explained above, according to the information reproducing apparatus of the present invention, it is provided with the first reading device, the second reading device, the notifying device, and the reproducing device. According to the information reproducing method of the present invention, it is provided with the first reading process, the second reading process, the notifying process, and the reproducing process. According to the managing apparatus of the present invention, it is provided with the notice information recognizing device and the notice information obtaining device. According to the managing method of the present invention, it is provided with the notice information recognizing process and the notice information obtaining process. According to the information reproducing system of the present invention, it is provided with the information reproducing apparatus, provided with the first reading device, the second reading device, the notifying device, and the reproducing device, and the managing apparatus, provided with the notice information recognizing device and the notice information obtaining device. According to the first computer program, it makes a computer function as one portion of the first reading device, the second reading device, the notifying device, and the reproducing device. According to the second computer program, it makes a computer function as the notice information recognizing device and the notice information obtaining device. Therefore, for example, it is possible to preferably reproduce the content information recorded on the plurality of information recording media such as local storages, and the content information recorded on the information recording medium, such as an optical disc.

### BRIEF DESCRIPTION OF DRAWINGS

FIG. 1 is a block diagram conceptually showing the basic structure of an information recording/reproducing system in an embodiment.

FIG. 2 is a block diagram conceptually showing the basic structure of an information recording/reproducing apparatus in the embodiment.

FIG. 3 is a block diagram conceptually showing the basic structure of a management server in the embodiment.

FIG. 4 is a tree structure diagram conceptually showing a basic file structure on an optical disc.

FIG. 5 is a tree structure diagram conceptually showing a basic file structure on a LS.

FIG. 6 is a tree structure diagram conceptually showing a basic file structure on a virtual file system.

FIG. 7 is flowchart conceptually showing one flow of the operations of the information recording/reproducing system in the embodiment.

FIG. 8 is flowchart conceptually showing another flow of the operations of the information recording/reproducing system in the embodiment.

FIG. 9 are tree structure diagrams conceptually showing specific file structures on a first LS, a second LS, and a third LS.

FIG. 10 is a tree structure diagram conceptually showing the file structure on the virtual file system, which is regenerated on the basis of the first LS, the second LS, and the third LS having the file structure shown in FIG. 9 and the optical disc having the file structure shown in FIG. 4.

FIG. 11 is an area structure diagram conceptually showing the area structure of the second LS.

FIG. 12 is a tree structure diagram conceptually showing the file structure in an area for plurality of LS in the second LS.

FIG. 13 is a data structure diagram conceptually showing one specific example of a LS configuration information file.

### DESCRIPTION OF REFERENCE CODES

1 information recording/reproducing system
10 information recording/reproducing apparatus
20 management server
100 optical disc
112 signal recording/reproducing device
113 CPU
113a file system generation device
113b notice information generation device 115 data recording/reproducing device
116 communication control device
121 first LS recording/reproducing device
122 first LS
123 second recording/reproducing device
124 second LS
125 third recording/reproducing device
126 third LS
213 CPU
213a integrated information generation device
216 communication control device

### BEST MODE FOR CARRYING OUT THE INVENTION

Hereinafter, the best mode for carrying out the present invention will be explained in each embodiment in order with reference to the drawings.

(1) Basic structure

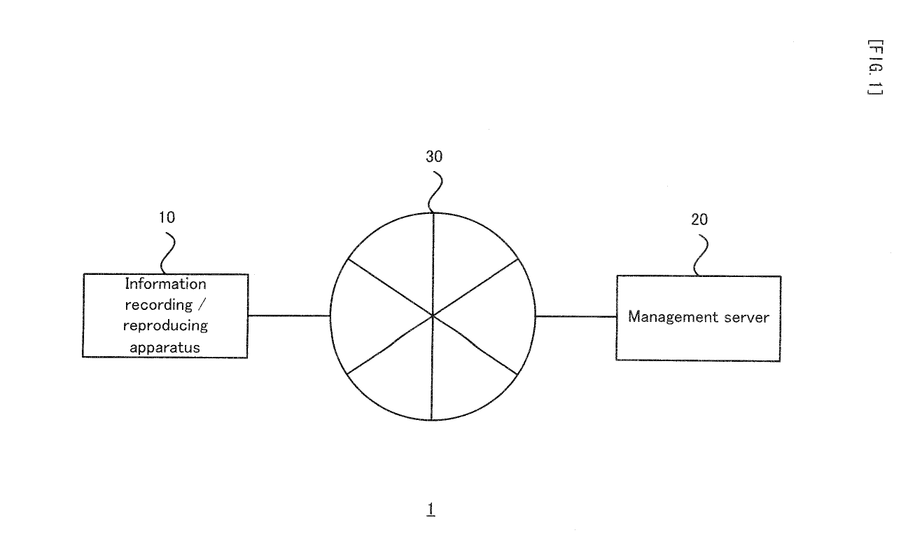

Firstly, with reference to FIG. 1 to FIG. 3, an explanation will be given on the basic structure of an embodiment of the present invention.

(1-1) Information Recording/Reproducing System

Firstly, with reference to FIG. 1, an explanation will be given on an information recording/reproducing system 1 in an embodiment according to the information reproducing system of the present invention (i.e. an information recording/reproducing system 1 provided with: an information recording/reproducing apparatus 10, which is an embodiment according to the information reproducing apparatus of the present invention; and a management server 20, which is an embodiment according to the managing apparatus of the present invention). FIG. 1 is a block diagram conceptually showing the basic structure of the information recording/reproducing system 1 in the embodiment.

As shown in FIG. 1, the information recording/reproducing system 1 in the embodiment is provided with: the information recording/reproducing apparatus 10; the management server 20; and a communication network 30.

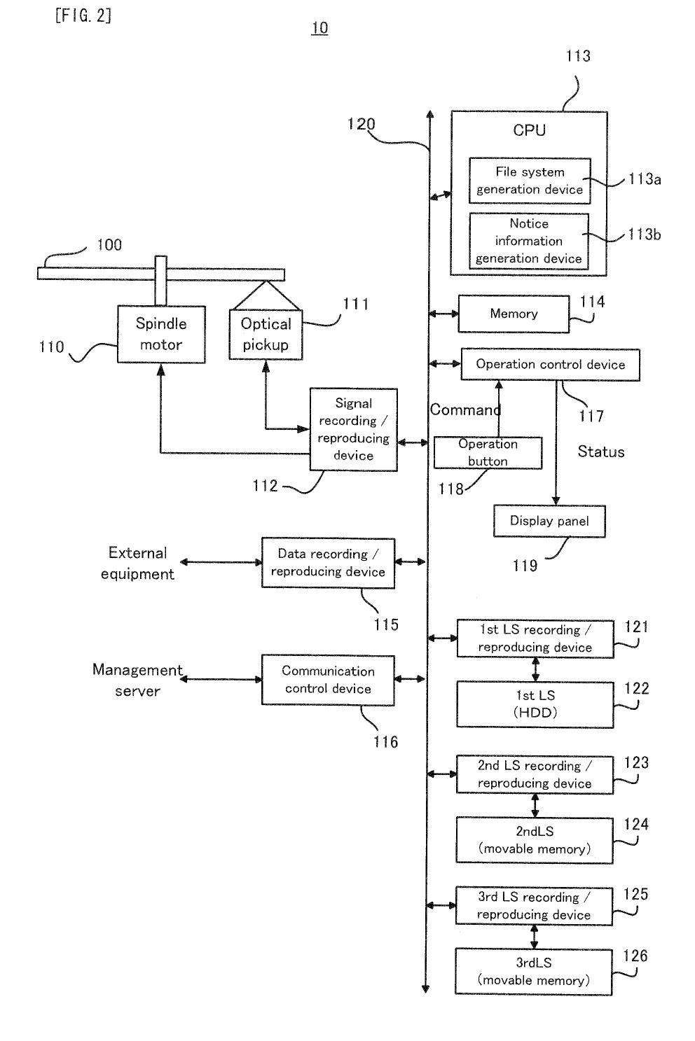

The information recording/reproducing apparatus 10 constitutes one specific example of the “information reproducing apparatus” of the present invention. The information recording/reproducing apparatus 10 is adapted to reproduce content information recorded on an optical disc 100, which constitutes one specific example of the “first information recording medium” of the present invention, and LS (Local Storages) 122, 124, and 126, which constitute one specific example of the “second information recording medium” of the present invention. Moreover, the information recording/reproducing apparatus 10 is adapted to record the content information onto the optical disc 100 and the LS 122, 124, and 126. In addition, the information recording/reproducing apparatus 10 is adopted to perform the transmission/reception of the information with the management server 20 through the communication network 30. Incidentally, the detailed structure of the information recording/reproducing apparatus 10 will be detailed later (refer to FIG. 2).

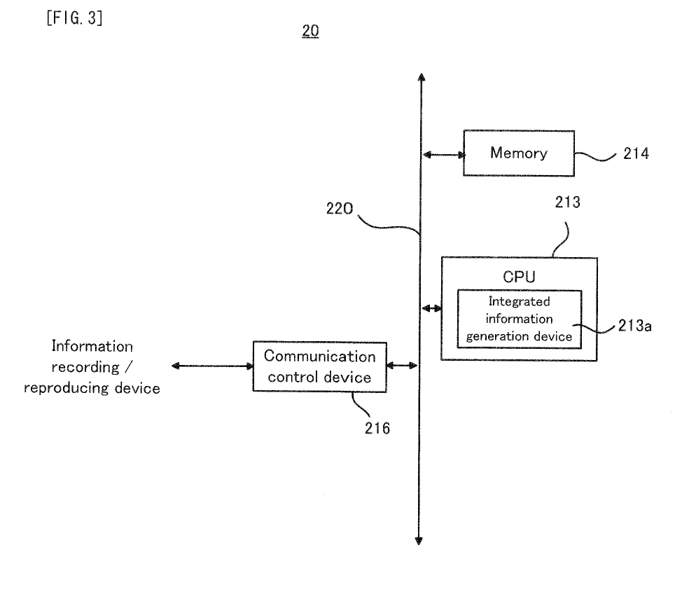

The management server 20 constitutes one specific example of the “managing apparatus” of the present invention. The management server 20 is used to manage the content information recorded on the optical disc 100 and the LS 122, 124, and 126. In addition, the management server 20 is adapted to perform the transmission/reception of the information with the information recording/reproducing apparatus 10 through the communication network 30. Incidentally, the detailed structure of the management server 20 will be detailed later (refer to FIG. 3).

The communication network 30 is a network for connecting the information recording/reproducing apparatus 10 and the management server 20. The communication network 30 may be an exclusive line, a general public line, a phone line, a packet network, a circuit switching network, or the like. Moreover, the Internet may be adopted as the communication network 30. Moreover, the communication network 30 may be a wireless network, such as a mobile phone network, IMT-2000, PHS or wireless LAN. Incidentally, the entire communication network between the information recording/reproducing apparatus 10 and the e management server 20 does not have to be wired or wireless. One portion of the communication line may be wired and another portion of the communication network 30 may be wireless.

Incidentally, FIG. 1 shows the information recording/reproducing system 1 in which one information recording/reproducing apparatus 10 and one management server 20 are connected to the communication network 30. However, it will be understood that a plurality of information recording/reproducing apparatuses 10 may be connected to one management server 20 through the communication network 30, that one information recording/reproducing apparatus 10 may be connected to a plurality of management servers 20 through the communication network 30, or that a plurality of information recording/reproducing apparatuses 10 may be connected to a plurality of management servers 20 through the communication network 30.

(1-2) Information Recording/Reproducing Apparatus

Next, with reference to FIG. 2, an explanation will be given on the basic structure of the information recording/reproducing apparatus 10 in the embodiment according to the information reproducing apparatus of the present invention. FIG. 2 is a block diagram conceptually showing the basic structure of the information recording/reproducing apparatus 10 in the embodiment.

As shown in FIG. 2, the information recording/reproducing apparatus 10 is provided with: a spindle motor 110; an optical pickup 111; a signal recording/reproducing device 112; a CPU 113; a memory 114; a data recording/reproducing device 115; a communication control device 116; an operation control device 117; an operation button 118; a display panel 119; a data bus 120; a first LS recording/reproducing device 121; a second LS recording/reproducing device 123; and a third LS recording/reproducing device 125.

The spindle motor 110 is intended to rotate and stop the optical disc 100, and operates in accessing the optical disc 100. More specifically, the spindle motor 110 is constructed to rotate the optical disc 100 at a predetermined speed and stop it, under the spindle servo provided by a not-illustrated servo unit or the like.

The optical pickup 111 is to perform the information recording/reproducing with respect to the optical disc 100, and includes a semiconductor laser apparatus, a collimator lens, and an objective lens or the like, which are not illustrated. More specifically, the optical pickup 111 irradiates the optical disc 100 with a light beam, such a laser beam, as reading light with a first power in the reproduction, and as writing light with a second power with it modulated in the recording.

The signal recording/reproducing device 112 constitutes one specific example of the “first reading device” of the present invention. The signal recording/reproducing device 112 performs the information recording/reproducing with respect to the optical disc 100 by controlling the spindle motor 110 and the optical pickup 111 under the control of the CPU 113. More specifically, the signal recording/reproducing device 112 includes a laser diode (LD) driver, a head amplifier, and the like. The LD driver generates for example, a driving pulse, and drives the semiconductor laser apparatus built in the optical pickup 111. The head amplifier amplifies the output signal of the optical pickup 111, i.e., the reflected light of the laser beam, and outputs the amplified signal to the data recording/reproducing device 115.

The CPU 113 is connected to the signal recording/reproducing device 112, the memory 114, the data recording/reproducing device 115, the communication control device 116, the operation control device 117, the first LS reading device 121, the second LS reading device 123, and the third LS reading device 125 via the bus 120, and controls the entire information recording/reproducing apparatus 10 by giving instructions to various control devices. In general, software or firmware for operating the CPU 113 is stored in the memory 114.

In particular in the embodiment, the CPU 113 is provided with: a file system generation device 113a; and a notice information generation device 113b.

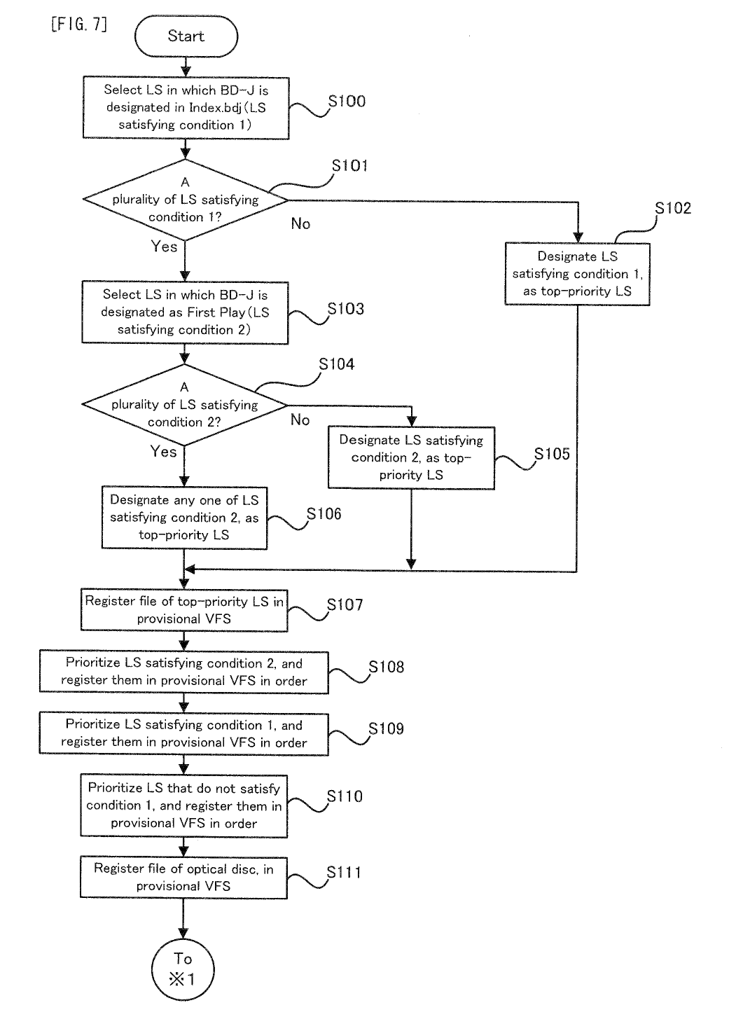

The file system generation device 113a constitutes one specific example of the “integrating device” and the “file system information generating device” of the present invention. The file system generation device 113a generates a virtual file system (VFS) for making the information recording/reproducing apparatus 10 recognize the content information recorded on the optical disc 100, the first LS 122, the second LS 124, and the third LS 126 as one directory hierarchy, logically. In other words, the file system generation device 113a generates the virtual file system which makes the information recording/reproducing apparatus 10 integrate the content information recorded on the optical disc 100, the first LS 122, the second LS 124, and the third LS 126, and manage them. The virtual file system constitutes one specific example of the “file system information” of the present invention. Incidentally, the more specific operations of the file system generation device 113a will be detailed later (refer to FIG. 7 and the like).

The notice information generation device 113b constitutes one specific example of the “notifying device” of the present invention, with the communication control device 116. The notice information generation device 113b is adapted to generate notice information which indicates a combination of the content information recorded on the optical disc 100, the first LS 122, the second LS 124, and the third LS 126. The generated notice information is transmitted to the management server 20 through the communication network 30, by the operations of the communication control device 116. Incidentally, the more specific operations of the notice information generation device 113b will be detailed later (refer to FIG. 7 and the like).

The memory 114 is used in the general data processing on the information recording/reproducing apparatus 10. The memory 114 includes: a Read Only Memory (ROM) area in which a program for the information recording/reproducing apparatus 10 to perform an operation (i.e., firmware) is stored; a Random Access Memory (RAM) area in which the data is temporarily stored or in which a parameter required for the operation of the firmware program or the like is stored; and the like.

The data recording/reproducing device 115 constitutes one specific example of the “reproducing device” of the present invention. The data recording/reproducing device 115 is adapted to reproduce the content information recorded on the optical disc 100, the first LS 122, the second LS 124, and the third LS 126. By this, the content information including video images and audio is actually outputted on external equipment, such as a display and a speaker.

The communication control device 116 constitutes one specific example of the “integrated information obtaining device” of the present invention. The communication control device 116 receives integrated information, which is transmitted through the communication network 30 from the management server 20, and outputs the received integrated information to the CPU 113 (more specifically, to the file system generation device 113a). Moreover, the communication control device 116 transmits the notice information, which is generated by the notice information generation device 113b, to the management server 20 through the communication network 30.

The operation control device 117 receives an operation instruction from the exterior with respect to the information recording/reproducing apparatus 10 and performs displaying related to the operations of the information recording/reproducing apparatus 10. The operation control device 117 sends the instruction by the operation bottom 118 including a recording button, a reproduction button, or the like, to the CPU 113. The CPU 113 outputs the operational state of the information recording/reproducing apparatus 10, such as during the recording and during the reproduction, to the display panel 119, such as a fluorescent tube and a LCD.

The first LS recording/reproducing device 121 constitutes one specific example of the “second reading device” and the “recording device” of the present invention. The first LS recording/reproducing device 121 records and reproduces the information with respect to the first LS 122, such as a hard disk, for example.

The second LS recording/reproducing device 123 constitutes one specific example of the “second reading device” and the “recording device” of the present invention. The second LS recording/reproducing device 123 records and reproduces the information with respect to the second LS 124, such as a movable memory (e.g. a SD card, a memory stick), for example. The second LS recording/reproducing device 123 can record and reproduce the information with respect to the second LS 124 if the second LS 124 is inserted into a memory slot disposed on the outside of the information recording/reproducing apparatus 10.

The third LS recording/reproducing device 125 constitutes one specific example of the “second reading device” and the “recording device” of the present invention. The third LS recording/reproducing device 125 records and reproduces the information with respect to the third LS 126, such as a movable memory (e.g. a SD card, a memory stick), for example. The third LS recording/reproducing device 125 can record and reproduce the information with respect to the third LS 126 if the third LS 126 is inserted into a memory slot disposed on the outside of the information recording/reproducing apparatus 10.

Incidentally, the LS indicates in effect the information recording medium additionally mounted or connected, except the information recording medium which is originally targeted by the information recording/reproducing apparatus 10 for the recording and reproduction (the optical disc 100 in the example in FIG. 2).

(1-3) Management Server

Next, with reference to FIG. 3, an explanation will be given on the basic structure of the management server 20 in the embodiment. FIG. 3 is a block diagram conceptually showing the basic structure of the management server 20 in the embodiment.

As shown in FIG. 3, the management server 20 in the embodiment is provided with: a CPU 213; a memory 214; a content database 215; a communication control device 216; and a data bus 220.

The CPU 213 is connected to the memory 214, the content database 215, and the communication control device 216 through the data bus 220, and controls the entire management server 20 by giving instructions to various control devices. Normally, software or firmware for operating the CPU 213 is stored in the memory 214.

In particular, in the embodiment, the CPU 213 is provided with an integrated information generation device 213a. The integrated information generation device 213a constitutes one specific example of the “integrated information generating device” of the present invention. The integrated information generation device 213a generates integrated information, which is necessary to generate the virtual file system for making the information recording/reproducing apparatus 10 recognize the content information recorded on the optical disc 100, the first LS 122, the second LS 124, and the third LS 126 as one directory hierarchy. Incidentally, the more specific operations of the integrated information generation device 213a will be detailed later (refer to FIG. 7 and the like).

The memory 214 is used in the general data processing on the management server 20. The memory 214 includes: a ROM area in which a program for the management server 20 to perform an operation (i.e., firmware) is stored; a RAM area in which the data is temporarily stored or in which a parameter required for the operation of the firmware program or the like is stored; and the like.

The communication control device 216 constitutes one specific example of the “notice information recognizing device” and the “notice information obtaining device” of the present invention. The communication control device 216 recognizes and receives the notice information, which is transmitted through the communication network 30 from the information recording/reproducing apparatus 10, and output the received integrated information to the CPU 213 (more specifically, the integrated information generation device 213a). Moreover, the communication control device 216 transmits the integrated information, which is generated by the integrated information generation device 213a, to the information recording/reproducing apparatus 10 through the communication network 30.

(2) File Structure

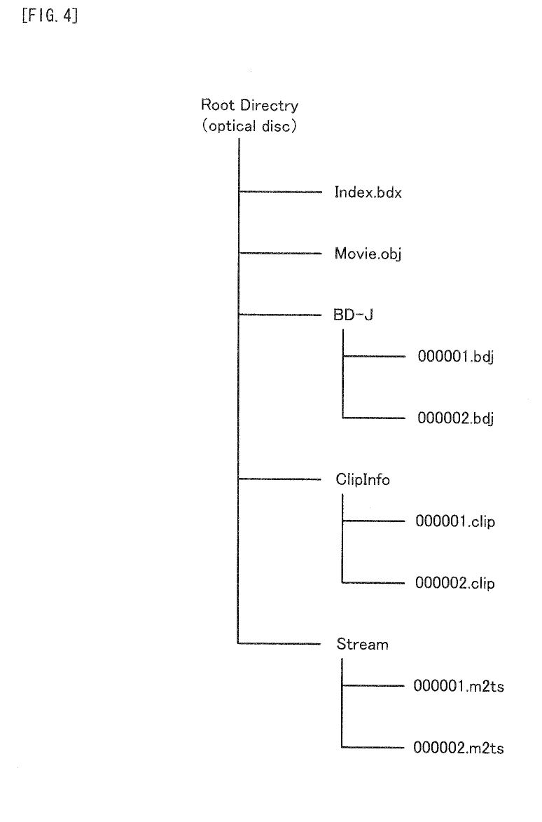

Next, with reference to FIG. 4 to FIG. 6, an explanation will be given on a basic file structure on the optical disc and the LS (in other words, a directory hierarchy structure), and a basic file structure of the virtual file system generated when they are integrated.

(2-1) File Structure on Optical Disc

Firstly, with reference to FIG. 4, the basic file structure on the optical disc 100 will be explained. FIG. 4 is a tree structure diagram conceptually showing the basic file structure on the optical disc 100.

As shown in FIG. 4, under the root directory of the optical disc 100, there are included: for example, Index.bdx (index file); Movie.obj (movie object file); BD-J (BD Java application object) including 000001.bdj and 000002.bdj (BD Java application object files); ClipInfo (clip information) including 000001.clip and 000002.clip (clip information files); and Stream including 000001.m2ts and 000002.m2ts (MPEG2 transport stream files).

In the Index.bdx, for example, pointer information is recorded which indicates which object is to be reproduced when the content information (specifically, for example, the content information including the video information, the audio information, and the sub-picture information) recorded on the optical disc 100 is reproduced.

In the Movie.obj, for example, pointer information is recorded which indicates which play list is to be referred to when the content information recorded on the optical disc 100 is reproduced.

In the BD-J, for example, Java application is recorded which is performed when the content information recorded on the optical disc 100 is reproduced.

In the ClipInfo, for example, information is recorded which is associated with the play list indicating a reproduction start position and a reproduction end position of the content information as a time stamp or the like and which is to convert the reproduction start position and the reproduction end position to addresses in a stream file.

In the Stream, for example, the stream of each of the video information, the audio information, and the sub-picture information is recorded. For example, the 000001.m2ts is a stream of the audio information associated with English audio, and the 000002.m2ts is a stream of the audio information associated with Japanese audio.

(2-2) File Structure on LS

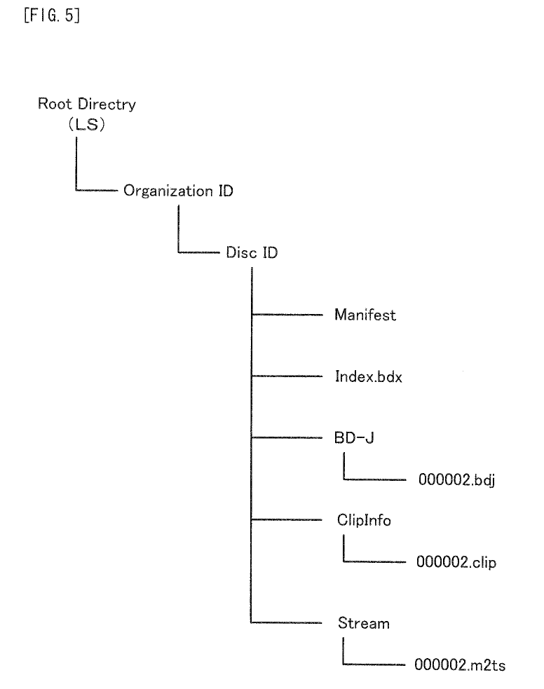

Next, with reference to FIG. 5, an explanation will be given on the basic file structure on the first LS 122, the second LS 124, or the third LS 126. FIG. 5 is a tree structure diagram conceptually showing the basic file structure on the LS.

Incidentally, in the explanation below, the basic file structure on the first LS 122 will be explained; however, it will be understood that the basic file structures on the second LS 124 and the third LS 126 are also the same.

As shown in FIG. 5, under the root directory of the first LS 122, Organization ID is included. The Organization ID is identification information for identifying an author, such as a movie company, who produces the content information.

Organization ID further includes Disc ID. The Disc ID is identification information for identifying the content information. For example, if the content information is a movie, the Disc ID is a title itself of the movie, or identification information for identifying the title.

By referring to the Organization ID and the Disc ID, it is possible to judge whether or not the content information recorded on the optical disc 100 matches the content information recorded in the first LS 122. If the content information recorded on the optical disc 100 matches the content information recorded in the first LS 122, the content information recorded in the first LS 122 can be reproduced together with, or in combination with, or in place of the content information recorded on the optical disc 100.

The Disc ID further includes: for example, Manifest (manifest file); Index.bdx; BD-J including 000002.bdj; ClipInfo including 000002.clip; and Stream including 000002.m2ts.

The Manifest includes: version information of the content information recorded in the first LS 122; and conversion information for converting a file name of each file recorded in the first LS 122.

The Index.bdx, the 000002.bdj, the 000002.clip, and the 000002.m2ts recorded in the first LS 122 are information that can be replaced with the Index.bdx, the 000002.bdj, the 000002.clip, and the 000002.m2ts recorded on the optical disc 100.

For example, it is assumed that 000001.m2ts which is a stream of the audio information associated with English audio and 000002.m2ts which is a stream of the audio information associated with Japanese audio are recorded on the optical disc 100. In this case, for example, 000002.m2ts which is a stream of the audio information associated with French audio is recorded in the first LS 122. Then, by replacing the 000002.m2ts recorded on the optical disc 100 with the 000002.m2ts recorded in the first LS 122, a movie can be reproduced with the French audio instead of the Japanese audio.

Moreover, for example, it is assumed that 000001.m2ts which is a stream of the sub-picture information associated with English subtitles and 000002.m2ts which is a stream of the sub-picture information associated with Japanese subtitles are recorded on the optical disc 100. In this case, for example, 000002.m2ts which is a stream of the sub-picture information associated with Chinese subtitles is recorded in the first LS 122. Then, by replacing the 000002.m2ts recorded on the optical disc 100 with the 000002.m2ts recorded in the first LS 122, a movie can be reproduced with the Chinese subtitles instead of the Japanese subtitles.

As described above, by combining the first LS 122, the second LS 124 and the third LS 126 as occasion demands in addition to the optical disc 100, it is possible to reproduce the content information recorded on the optical disc 100 in various types of aspects.

Incidentally, in the file structure shown in FIG. 5, the file name of the file recorded in the first LS 122 is the same as the file name of the file recorded on the optical disc 100. In practice, the file having another file name is recorded in the first LS 122, but the Manifest causes the file name of the file recorded in the first LS 122 to be converted so as to have the same file name of the file recorded on the optical disc 100. However, the file name of the file recorded in the first LS 122 may be the same as the file name of the file recorded on the optical disc 100.

(2-3) File Structure on Virtual File System

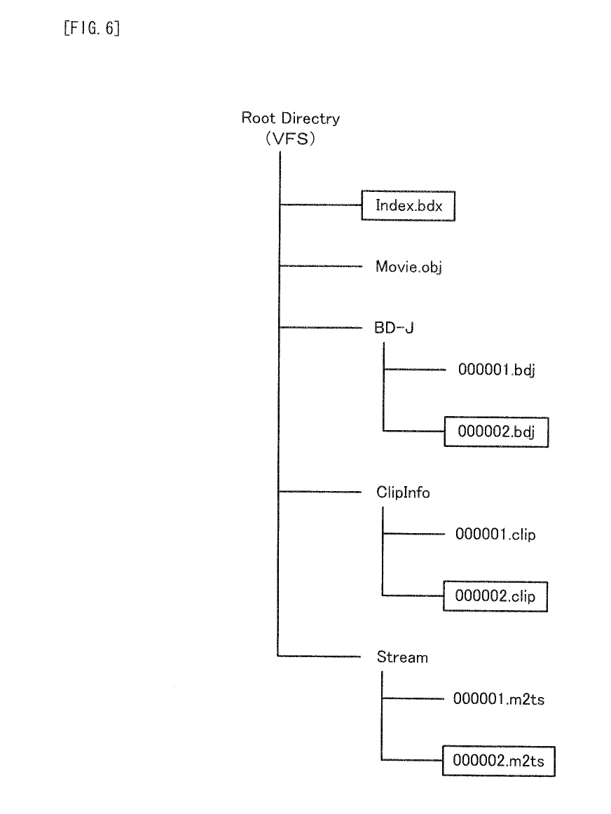

Next, with reference to FIG. 6, the basic file structure on the virtual file system will be explained. FIG. 6 is a tree structure diagram conceptually showing the basic file structure on the virtual file system.

Incidentally, the virtual file system is a file system generated by the information recording/reproducing apparatus 10 (more specifically, the file system generation device 113a) when the content information recorded in the first LS 122, the second LS 124, and the third LS 126 is reproduced together with, or in combination with, or in place of the content information recorded on the optical disc 100. The information recording/reproducing apparatus 10 can reproduce the content information by recognizing that the content information recorded on the optical disc 100 and the content information recorded in the first LS 122, the second LS 124, and the third LS 126 are the content information logically constructed by one directory hierarchy, using the virtual file system.

In the explanation on FIG. 6 below, an explanation will be given on the file structure on the virtual file system generated when the content information recorded in the first LS 122 is reproduced together with the content information recorded on the optical disc 100. That is, an explanation will be given on the file structure on the virtual file system generated when the content information recorded in one LS is reproduced together with the content information recorded on the optical disc 100. In this case, the virtual system is generated by preferentially registering the content information recorded in the first LS 122 in the virtual file system, and then registering the content information recorded on the optical disc 100 in the virtual file system.

As shown in FIG. 6, instead of the Index.bdx, the 000002.bdj, the 000002.clip, and the 000002.m2ts recorded on the optical disc 100, the Index.bdx, the 000002.bdj, the 000002.clip, and the 000002.m2ts recorded in the first LS 122 are registered in the virtual file system. That is, in FIG. 6, the files surrounded by rectangular frames are the files recorded in the first LS 122, and the files not surrounded by the rectangular frames are the files recorded on the optical disc 100. By this, the information recording/reproducing apparatus 10 can recognize that the content information recorded on the optical disc 100 and the content information recorded in the first LS 122 are logically constructed by one directory hierarchy. As a result, the content information recorded in the first LS 122 can be reproduced together with the content information recorded on the optical disc 100.

Of course, the 000002.bdj, the 000002.clip, and the 000002.m2ts recorded in the first LS 122 as well as the 000002.bdj, the 000002.clip, and the 000002.m2ts recorded on the optical disc 100 may be registered in the virtual file system. Specifically, the 000002.bdj, the 000002.clip, and the 000002.m2ts recorded in the first LS 122 may be converted to have the file names 000003.bdj, 000003.clip, and 000003.m2ts, respectively, and thereby they are registered in the virtual file system without deleting the 000002.bdj, the 000002.clip, and the 000002.m2ts recorded on the optical disc 100.

As described above, when the content information recorded in one LS is reproduced together with the content information recorded on the optical disc 100, it is only necessary to simply preferentially register the content information recorded in the LS, in the virtual file system, and then register the content information recorded on the optical disc 100 in the virtual file system. On the other hand, when the content information recorded in each of the plurality of LS is reproduced together with the content information recorded on the optical disc 100, the operations explained in the following item of operation principle are performed to thereby generate the virtual file system.

(3) Operation Principle

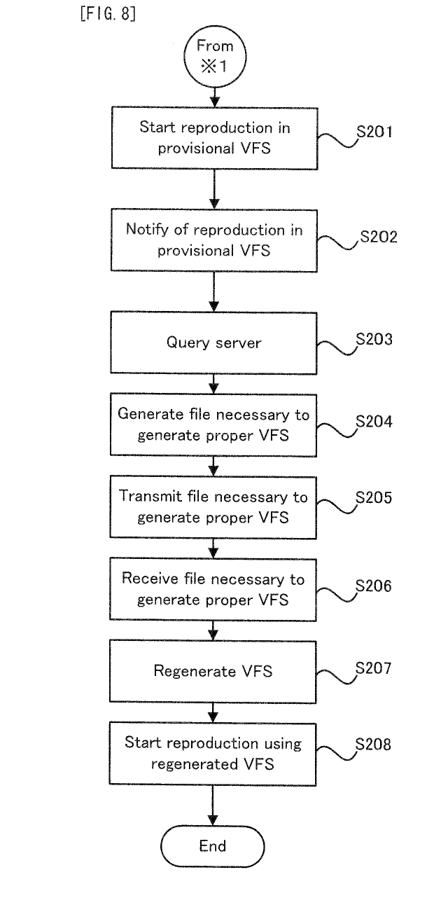

Next with reference to FIG. 7 and FIG. 8, an explanation will be given on an operation principle in the information recording/reproducing system 1 in the embodiment. Specifically, an explanation will be given on the operations when the content information recorded in each of the plurality of LS is reproduced together with the content information recorded on the optical disc 100. FIG. 7 is flowchart conceptually showing one flow of the operations of the information recording/reproducing system 1 in the embodiment. FIG. 8 is flowchart conceptually showing another flow of the operations of the information recording/reproducing system 1 in the embodiment.

As shown in FIG. 7, firstly, from among the plurality of LS mounted on or connected to the information recording/reproducing apparatus 10, a LS in which the BD-J is designated in the Index.bdj (hereinafter referred to as the “LS satisfying a condition 1” as occasion demands) is selected (step S100). That is, a LS in which the Index.bdj including the pointer information which indicates that the BD Java application object is to be reproduced is recorded is selected. Then, it is judged whether or not there are a plurality of LS satisfying the condition 1 (step S101).

As a result of the judgment in the step S101, if it is judged that there are not the plurality of LS satisfying the condition 1 (i.e. there is one LS satisfying the condition 1) (the step S101: No), the LS satisfying the condition 1, selected in the step S100, is designated as the top-priority LS when the virtual file system is generated (step S102).

On the other hand, as a result of the judgment in the step S101, if it is judged that there are the plurality of LS satisfying the condition 1 (the step S101: Yes), then, from among the plurality of LS satisfying the condition 1, a LS in which the BD-J is designated as First Play in the Index.bdj (hereinafter referred to as the “LS satisfying a condition 2” as occasion demands) is selected (step S103). That is, a LS in which the Index.bdj including the pointer information which indicates that the BD Java application object is to be firstly reproduced is recorded is selected. Then, it is judged whether or not there are a plurality of LS satisfying the condition 2 (step S104).

As a result of the judgment in the step S104, if it is judged that there are not the plurality of LS satisfying the condition 2 (i.e. there is one LS satisfying the condition 2) (the step S104: No), the LS satisfying the condition 2, selected in the step S103, is designated as the top-priority LS when the virtual file system is generated (step S105).

On the other hand, as a result of the judgment in the step S104, if it is judged that there are the plurality of LS satisfying the condition 2 (the step S104: Yes), then, any one LS of the plurality of LS satisfying the condition 2 is designated as the top-priority LS when the virtual file system is generated (step S106). Any one LS may be designated using random number calculation or the like.

Then, by virtue of the operations of the file system generation device 113a, the files recorded in the top-priority LS designated in the step S102, the step S105 or the step S106 are registered in a provisional virtual file system (step S107). Here, the “provisional virtual file system” is a term used to distinguish it from the proper virtual file system generated later. The “provisional virtual file system” indicates in effect the virtual file system provisionally generated before the information exchange between the information recording/reproducing apparatus 10 and the management server 20.

Then, the LS satisfying the condition 2 is registered in the provisional virtual file system (step S108). If there is only one LS satisfying the condition 2, since the LS is designated as the top-priority LS, the process in the step S108 does not have to be performed. On the other hand, if there are the plurality of LS satisfying the condition 2, rating is arbitrarily performed on the LS other than the LS designated as the top-priority LS, by using the random number calculation or the like, and they are registered in the provisional virtual file system in the ranked order.

Then, the LS satisfying the condition 1 is registered in the provisional virtual file system (step S109). If there is only one LS satisfying the condition 1, since the LS is designated as the top-priority LS, the process in the step S109 does not have to be performed. On the other hand, if there are the plurality of LS satisfying the condition 1, rating is arbitrarily performed on the LS other than the LS designated as the top-priority LS, by using the random number calculation or the like, and they are registered in the provisional virtual file system in the ranked order.

Then, the LS that does not satisfy the condition 1 is registered in the provisional virtual file system (step S110). If there are the plurality of LS that do not satisfy the condition 1, rating is arbitrarily performed on the LS other than the LS designated as the top-priority LS, by using the random number calculation or the like, and they are registered in the provisional virtual file system in the ranked order.

Then, the file on the optical disc 100 is registered in the provisional virtual file system (step S111). Then, the operational flow goes to *1 in FIG. 8.

Incidentally, all the operations between the step S100 and the step S111 are performed on the information recording/reproducing apparatus 10 side.

Then, as shown in FIG. 8, by using the provisional virtual file system generated by the operations shown in FIG. 7, the reproduction of the content information is started (step S201). Specifically, the reproduction of the object (e.g. the aforementioned BD-J) in the provisional virtual file system which the Index.bdj designates as the First Play is started.

Then, the information recording/reproducing apparatus 10 notifies the BD-J performed on e.g. a virtual machine formed on the information recording/reproducing apparatus 10, of the reproduction based on the provisional virtual file system (step S202). This notice may include a meaning of a failure in the virtual file system establishment.

The BD-J that is notified queries the management server 20 (step S203). Specifically, the BD-J requests the transmission of information which is necessary to generate the proper virtual file system for making the information recording/reproducing apparatus 10 recognize the content information recorded on the optical disc 100 and the content information recorded in the plurality of LS as one directory hierarchy, logically (i.e. the virtual file system for preferably reproducing the content information recorded in the first LS 122, the second LS 124, and the third LS 126 together with the content information recorded on the optical disc 100).

At this time, the BD-J also transmits, to the management server 20, the notice information generated by the operation of the notice information generation device 113b provided for the information recording/reproducing apparatus 10. The notice information includes information which indicates the files recorded in the plurality of LS.

The management server 20 which receives the query from the BD-J generates the information which is necessary to generate the proper virtual file system, by the operation of the integrated information generation device 213a (step S204). For example, the manifest which is used to preferably convert the file names of the files included in the plurality of LS, the correct Index.bdj, and other play list information and the like are generated as the information which is necessary to generate the proper virtual file system.

The “information which is necessary to generate the proper virtual file system” constitutes one specific example of the “integrated information” of the present invention.

Then, the management server 20 transmits the information which is necessary to generate the proper virtual file system, generated in the step S204, to the information recording/reproducing apparatus 10 (step S205).

Then, the BD-J receives the information which is necessary to generate the proper virtual file system, transmitted in the step S205, through the communication control device 116 (step S206). Then, the BD-J gives an instruction to the information recording/reproducing apparatus 10 to regenerate the virtual file system by using the received information which is necessary to generate the proper virtual file system.

As a result, the information recording/reproducing apparatus 10 (more specifically, the file system generation device 113a) regenerates the proper virtual file system (step S207). Then, by using the virtual file system regenerated in the step S207, the reproduction of the content information recorded on the optical disc 100 and the plurality of LS is started (step S208).

Incidentally, the operations between the step S201 and the step S203 and the operations between the step S206 and the step S208 are performed on the information recording/reproducing apparatus 10 side, and the operations in the step S204 and the step S205 are performed on the management server 20 side.

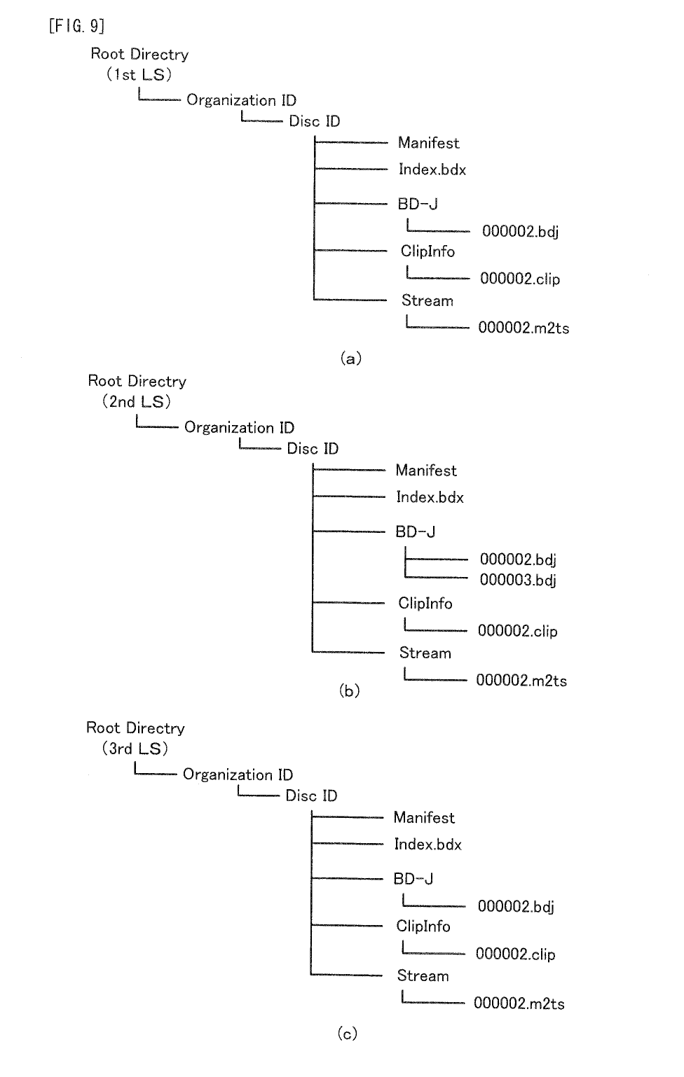

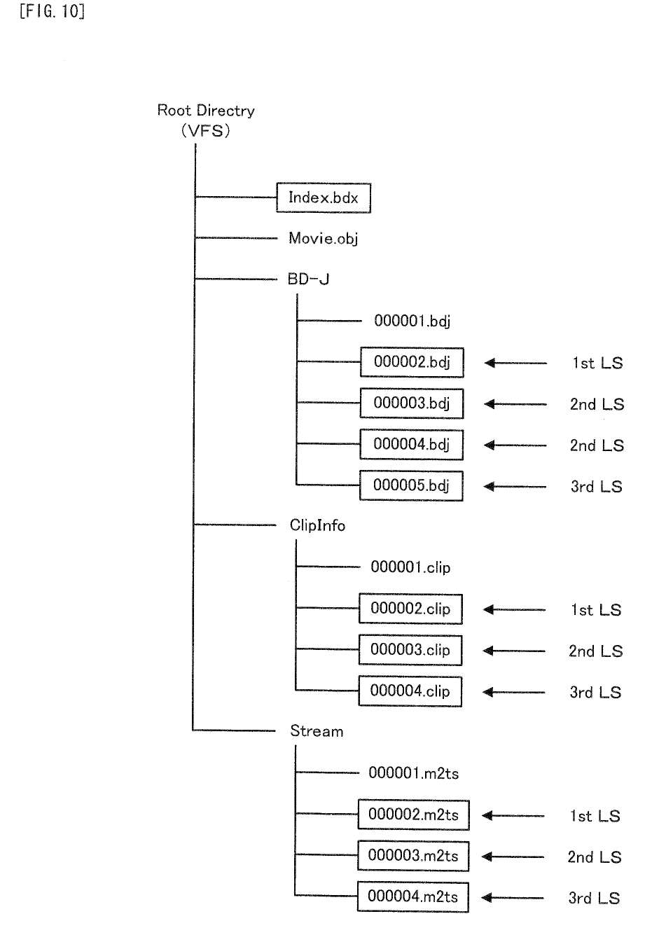

Now, with reference to FIG. 9 and FIG. 10, an explanation will be given on an aspect of regenerating the virtual file system. FIG. 9 are tree structure diagrams conceptually showing specific file structures on the first LS 122, the second LS 124, and the third LS 126. FIG. 10 is a tree structure diagram conceptually showing the file structure on the virtual file system, which is regenerated on the basis of the first LS 122, the second LS 124, and the third LS 126 having the file structure shown in FIG. 9 and the optical disc 100 having the file structure shown in FIG. 4 (in other words, the proper virtual file system).

As shown in FIG. 9(a), it is assumed that in the first LS 122, there are recorded: BD-J including 000002.bdj; ClipInfo including 000002.clip; and Stream including 000002.m2ts. Moreover, as shown in FIG. 9(b), it is assumed that in the second LS 124, there are recorded: BD-J including 000002.bdj and 000003.bdj; ClipInfo including 000002.clip; and Stream including 000002.m2ts. Moreover, as shown in FIG. 9(c), it is assumed that in the third LS 126, there are recorded: BD-J including 000002.bdj; ClipInfo including 000002.clip; and Stream including 000002.m2ts.

FIG. 10 shows the proper virtual file system regenerated on the basis of the optical disc 100 having the file structure shown in FIG. 4 and the first LS 122, the second LS 124, and the third LS 126 having the file structure described above.

As shown in FIG. 10, instead of the 000002.bdj, the 000002.clip, and the 000002.m2ts recorded on the optical disc 100, the 000002.bdj, the 000002.clip, and the 000002.m2ts recorded in the first LS 122 are registered in the virtual file system. Moreover, the 000002.bdj, the 000003.bdj, the 000002.clip, and the 000002.m2ts recorded in the second LS 124 are registered in the virtual file system after their file names are changed to 000003.bdj, 000004.bdj, 000003.clip, and 000003.m2ts, respectively. Moreover, the 000002.bdj, the 000002.clip, and the 000002.m2ts recorded in the third LS 126 are registered in the virtual file system after their file names are changed to 000005.bdj, 000004.clip, and 000004.m2ts, respectively. Moreover, the Index.bdj is replaced by preferable Index.bdj (specifically, Index.bdj which is conformity with the virtual file system shown in FIG. 10), by using e.g. the information transmitted from the management server 20.

The information recording/reproducing apparatus 10 can recognize that the content information recorded on the optical disc 100 and the content information recorded in the first LS 122, the second LS 124, and the third LS 126 are logically constructed by one directory hierarchy, with reference to the virtual file system shown in FIG. 10. As a result, it is possible to reproduce the content information recorded in the first LS 122, the second LS 124, and the third LS 126, together with the content information recorded on the optical disc 100.

As explained above, according to the information recording/reproducing system 1 in the embodiment, it is possible to preferably reproduce the content information recorded in the plurality of LS together with the content information recorded on the optical disc 100.

If the virtual file system is not generated in the aforementioned operations, a user needs to select one desired LS from among the plurality of LS and to generate the virtual file system from the one desired LS and the optical disc 100. Moreover, if it is desired to reproduce the content information recorded in the other LS except the selected desired LS, the selection operation and the operation of generating the virtual file system are necessary at each time. According to the embodiment, however, it is possible to generate the virtual file system, with the plurality of LS collectively used. Thus, without a user's help, it is possible to preferably reproduce the content information recorded in the plurality of LS, together with the content information recorded on the optical disc 100.

Incidentally, in the aforementioned embodiment, it is the three LS that are mounted on or connected to the information recording/reproducing apparatus 10. However, it will be understood that the number of LS may be two, or four or more. Moreover, the number of LS may be one or zero. If the two or more LS are mounted on or connected to the information recording/reproducing apparatus 10, it is necessary to perform the operations explained with reference to FIG. 7 and FIG. 8, to thereby regenerate the proper virtual file system. If one LS is mounted on or connected to the information recording/reproducing apparatus 10, it is only necessary to preferentially register the files recorded in the LS in the virtual file system, as explained in FIG. 6. If the LS is not mounted on nor connected to the information recording/reproducing apparatus 10, simply, it is only necessary to reproduce the content information recorded on the optical disc 100 (in other words, the virtual file system is not necessarily generated).

(4) Example of Modified Operation

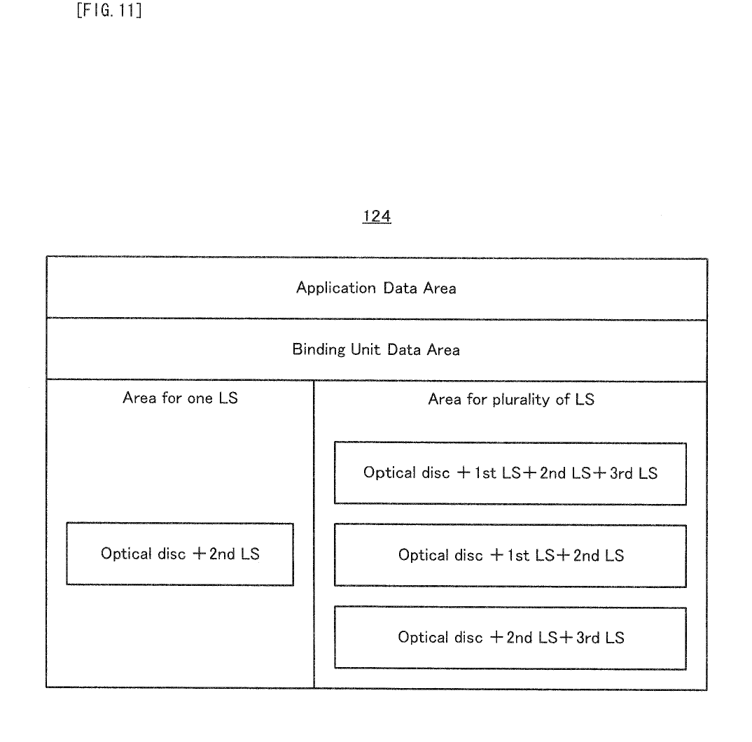

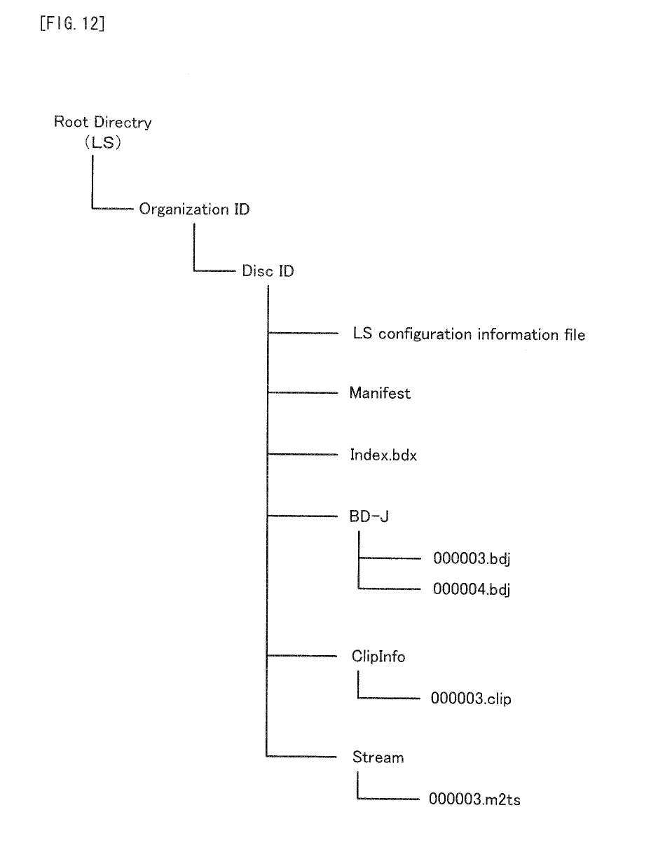

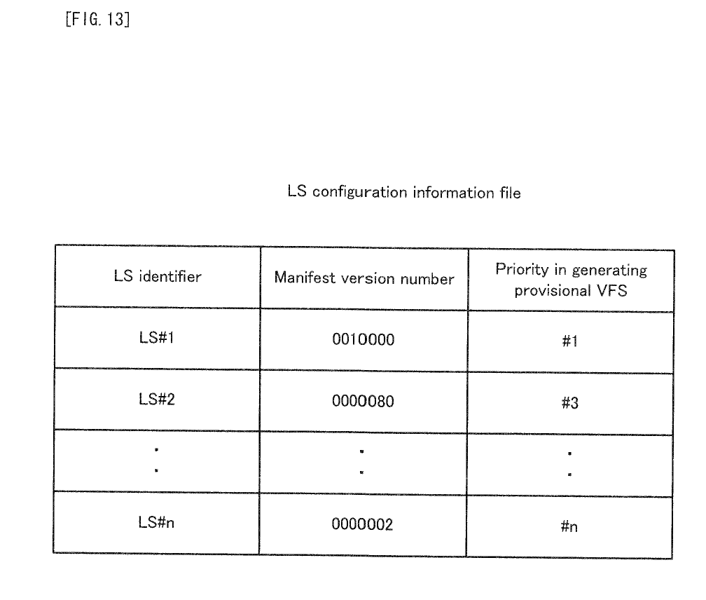

Next, with reference to FIG. 11 to FIG. 13, an explanation will be given on an example of the modified example of the information recording/reproducing system 1 in the embodiment. FIG. 11 is an area structure diagram conceptually showing the area structure of the second LS 124. FIG. 12 is a tree structure diagram conceptually showing the file structure in an area for plurality of LS in the second LS 124. FIG. 13 is a data structure diagram conceptually showing one specific example of a LS configuration information file.

In the example of the modified operation, if the proper virtual file system is regenerated in the step S207 in FIG. 8, information about the files which constitute the proper virtual file system is recorded into at least one of the plurality of LS (e.g. the second LS 124). The “information about the files which constitute the proper virtual file system” corresponds to one specific example of the “configuration information”.

In this case, as shown in FIG. 11, the information about the files which constitute the proper virtual file system is preferably recorded in the area for the plurality of LS, which is different from the area for one LS which is an area for the files originally recorded in the second LS 124. That is, without overwriting the files originally recorded in the second LS 124 (i.e. with the files remaining), the information about the files which constitute the proper virtual file system is preferably redundantly recorded in the second LS 124. More specifically, the area in the second LS 124 is divided into: an Application Data Area, which stores Cookie or the like and which has a relatively small capacity; and a Binding Unit Data Area in which the actual files are recorded and which has a relatively large capacity. The Binding Unit Data Area is provided with (i) the area for one LS and (ii) the area for the plurality of LS. Then, in the area for one LS, the files used in generating the virtual file system only from the optical disc 100 and one LS (i.e. the second LS 124 itself) are recorded. On the other hand, in the area for the plurality of LS, the files used in generating the virtual file system from the optical disc 100 and the plurality of LS are recorded.

Moreover, in the area for the plurality of LS, the information about the files which constitute the proper virtual file system may be recorded in each combination of the LS in generating the virtual file system. Specifically, for example, in the example shown in FIG. 11, (i) the information about the files which constitute the virtual file system generated from the optical disc 100, the first LS 122, the second LS 124, and the third LS 126, (ii) the information about the files which constitute the virtual file system generated from the optical disc 100, the first LS 122, and the second LS 124, and (iii) the information about the files which constitute the virtual file system generated from the optical disc 100, the second LS 124 and the third LS 126, may be recorded, separately and independently.

FIG. 12 shows the file structure in the area for the plurality of LS. As shown in FIG. 12, the file structure in the area for the plurality of LS further includes a LS configuration information file, in addition to the file structure shown in FIG. 5 (i.e. the file structure in the one LS area).

The LS configuration information file, as shown in FIG. 13, includes: a LS identifier including e.g. Organization ID and Disc ID; a Manifest version number; priority of each LS in generating the provisional virtual file system.

Moreover, in the area for the plurality of LS, the file name is converted and recorded such that the file name of each file is to be same as the file name on the proper virtual file system, by the Manifest. In other words, in the area for the plurality of LS, the Manifest is recorded which can convert the file name of each file name such that the file name of each file is to be same as the file name on the proper virtual file system.

By this, if the plurality of LS are mounted or connected, the information recording/reproducing apparatus 10 can judge whether or not the combination of the files recorded in the LS when the proper virtual file system was generated in the past is the same as the combination of the files recorded in the plurality of LS which are currently mounted or connected, with reference to the area for the plurality of LS in each LS. This judgment is performed with reference to the LS identifier such as the Organization ID and the Disc ID of the LS, the Version number of the Manifest file included in the LS configuration information file, or the like. Specifically, if the Organization ID and the Disc ID of the LS matches, and if the Version number of the Manifest file matches, it is judged that the combination of the files recorded in the LS when the proper virtual file system was generated in the past is the same as the combination of the files recorded in the plurality of LS which are currently mounted or connected. As a result, if the combination of the files recorded in the LS when the proper virtual file system was generated in the past is the same as the combination of the files recorded in the plurality of LS which are currently mounted or connected, it is possible to generate the proper virtual file system, by using the information recorded in the plurality of LS areas, it is possible to generate the proper virtual file system without performing again the query with respect to the management server 20 and the transmission of the information which is necessary to generate the proper virtual file system from the management server 20 to the information recording/reproducing apparatus 10. Thus, it is possible to generate the proper virtual file system, relatively efficiently.

Incidentally, the recording operation on the LS is performed by the operation of the BD-J. That is, the BD-J controls the operations of the first LS recording/reproducing device 121, the second LS recording/reproducing device 123, and the third LS recording/reproducing device 125, to thereby perform the recording operation on the first LS 122, the second LS 124, and the third LS 126. Moreover, the BD-J can also perform the reproduction operation on the first LS 122, the second LS 124, and the third LS 126.

On the other hand, the information recording/reproducing apparatus 10 itself does not perform the recording operation on the first LS 122, the second LS 124, and the third LS 126, but can perform the reproduction operation on the first LS 122, the second LS 124, and the third LS 126. Thus, the operations in FIG. 11 to FIG. 13 are preferably performed under the control of the BD-J.

Incidentally, the “information which is necessary to generate the proper virtual file system”, transmitted from the management server 20 to the information recording/reproducing apparatus 10, may be recorded into at least one of the plurality of LS. Alternatively, the structure or configuration of the proper virtual file system may be recorded in at least one of the plurality of LS. In any case, it is possible to generate the proper virtual file system without performing again the query with respect to the management server 20 and the transmission of the information which is necessary to generate the proper virtual file system from the management server 20 to the information recording/reproducing apparatus 10.

Moreover, the information is preferably recorded in the LS that does not have portability (e.g. a hard disk or the like, fixedly connected to the information recording/reproducing apparatus 10) of the plurality of LS. By this, it is possible to relatively reduce the occurrence of such a situation that the LS in which the information about the files which constitute the proper virtual file system is recorded is not mounted on nor connected to the information recording/reproducing apparatus 10. Therefore, it is possible to relatively reduce the frequency that the query with respect to the management server 20 and the transmission of the information which is necessary to generate the proper virtual file system from the management server 20 to the information recording/reproducing apparatus 10 are performed again.

In addition, in the aforementioned explanation, the second LS 124 is explained; however, it will be understood that the same operation can be performed on the first LS 122 and the third LS 126.

Incidentally, in the aforementioned embodiments, the optical disc 100 is explained as one example of the information recording medium, and the player related to the optical disc 100 is explained as one example of the information reproducing apparatus. The present invention, however, is not limited to the optical disc and the player thereof, and can be applied to other various information recording media which support high-density recording or a high transfer rate, and players thereof.

The present invention is not limited to the aforementioned embodiment, but various changes may be made, if desired, without departing from the essence or spirit of the invention which can be read from the claims and the entire specification. An information reproducing apparatus and method, a managing apparatus and method, an information reproducing system, and a computer program, all of which involve such changes, are also intended to be within the technical scope of the present invention.

### INDUSTRIAL APPLICABILITY

The information reproducing apparatus and method, the managing apparatus and method, the information reproducing system, and the computer program according to the present invention can be applied to an information reproducing apparatus and method, such as a Blu-ray Disc player, a managing apparatus, such as a management server, for managing content information which is reproduced by the information reproducing apparatus, an information reproducing system provided with the information reproducing apparatus and the managing apparatus. Moreover, they can be applied to an information reproducing apparatus, a managing apparatus, an information reproducing system, or the like which is mounted on various computer equipment for consumer use or for commercial use, or which can be connected to various computer equipment.

1. An information reproducing apparatus comprising:
a first reading device for reading main content information which is recorded on a first information recording medium;
a second reading device for reading additional content information which is to be reproduced with the main content information from a plurality of second information recording media on each of which the additional content information is recorded;
a notifying device for notifying a managing apparatus which manages the main content information and the additional content information of notice information which indicates the main content information and the additional content information; and
a reproducing device for reproducing the main content information and the additional content information.

2. The information reproducing apparatus according to claim 1, further comprising:
an integrated information obtaining device for obtaining integrated information which is transmitted from said managing apparatus that is notified of the notice information and which is to integrate the main content information and the additional content information; and
an integrating device for integrating the main content information and the additional content information by using the integrated information obtained by said integrated information obtaining device,
said reproducing device reproducing the main content information and the additional content information that are integrated.

3. The information reproducing apparatus according to claim 2, wherein
said integrating device integrates the main content information and the additional content information by generating file system information which is to integrate and manage the main content information and the additional content information, and
said reproducing device reproduces the main content information and the additional content information on the basis of the file system information.

4. The information reproducing apparatus according to claim 2, further comprising a recording device for recording configuration information, which indicates a structure of the main content information and the additional content information that are integrated, onto at least one of the plurality of second information recording media.

5. The information reproducing apparatus according to claim 4, wherein if the configuration information is recorded on at least one of the plurality of second information recording media and if the additional content information, which is to be read by said second reading device, is the same as the additional content information included in the main content information and the additional content information that are integrated, whose structure is indicated by the configuration information,
said notifying device does not notify said managing apparatus of the notice information, and
said integrating device integrates the main content information and the additional content information by using the configuration information.

6. The information reproducing apparatus according to claim 1, further comprising a file system information generating device for generating provisional file system information by prioritizing the additional content information and registering the additional content information in the order of descending priorities in file system information which is to integrate and manage the main content information and the additional content information,
said reproducing device starting the reproduction of the main content information and the additional content information on the basis of the provisional file system information,
said notifying device notifying said managing apparatus of the reproduction based on the provisional file system information as the notice information.

7. The information reproducing apparatus according to claim 1, wherein
the additional content information is recorded on the first information recording medium in addition to the main content information, and
said first reading device reads the additional content information recorded on the first information recording medium.

8. An information reproducing method comprising:
a first reading process of reading main content information which is recorded on a first information recording medium;
a second reading process of reading additional content information which is to be reproduced with the main content information from a plurality of second information recording media on each of which the additional content information is recorded;
a notifying process of notifying a managing apparatus which manages the main content information and the additional content information of notice information which indicates the main content information and the additional content information; and
a reproducing process of reproducing the main content information and the additional content information.

9. A managing apparatus for managing main content information, which is recorded on a first information recording medium mounted on an information reproducing apparatus, and additional content information, which is to be reproduced with the main content information and which is recorded on a plurality of second information recording media mounted on said information reproducing apparatus with the first recording medium,
said managing apparatus comprising:
a notice information recognizing device for recognizing an operation of said information reproducing apparatus which notifies said managing apparatus of notice information which indicates the main content information and the additional content information; and
a notice information obtaining device for obtaining the notice information of which said managing apparatus is notified by said information reproducing apparatus.

10. The managing apparatus according to claim 9, further comprising an integrated information generating device for generating integrated information, which is to integrate the main content information and the additional content information, on the basis of the notice information obtained by said notice information obtaining device.

11. The managing apparatus according to claim 10, further comprising a transmitting device for transmitting the integrated information generated by said integrated information generating device, to said information reproducing apparatus.

12. A managing method of managing main content information and additional content information in a managing apparatus which manages the main content information, which is recorded on a first information recording medium mounted on an information reproducing apparatus, and the additional content information, which is to be reproduced with the main content information and which is recorded on a plurality of second information recording media mounted on said information reproducing apparatus with the first recording medium,
said managing method comprising:
a notice information recognizing process of recognizing an operation of said information reproducing apparatus which notifies said managing apparatus of notice information which indicates the main content information and the additional content information; and
a notice information obtaining process of obtaining the notice information of which said managing apparatus is notified by said information reproducing apparatus.

13. An information reproducing system comprising:
an information reproducing apparatus; and
a managing apparatus,
said information reproducing apparatus comprising:
a first reading device for reading main content information which is recorded on a first information recording medium;
a second reading device for reading additional content information which is to be reproduced with the main content information from a plurality of second information recording media on each of which the additional content information is recorded;
a notifying device for notifying of notice information which indicates the main content information and the additional content information; and
a reproducing device for reproducing the main content information and the additional content information,
said managing apparatus comprising:
a notice information recognizing device for recognizing an operation of said information reproducing apparatus which notifies said managing apparatus of the notice information; and
a notice information obtaining device for obtaining the notice information of which said managing apparatus is notified by said information reproducing apparatus.

14. The information reproducing system according to claim 13, wherein
said managing apparatus further comprises an integrated information generating device for generating integrated information, which is to integrate the main content information and the additional content information, on the basis of the notice information obtained by said notice information obtaining device,
said information reproducing apparatus further comprises:
an integrated information obtaining device for obtaining the integrated information; and
an integrating device for integrating the main content information and the additional content information by using the integrated information obtained by said integrated information obtaining device, and
said reproducing device reproduces the main content information and the additional content information that are integrated.

15. A recording medium recording thereon a computer program for controlling a computer provided for an information reproducing apparatus comprising: a first reading device for reading main content information which is recorded on a first information recording medium; a second reading device for reading additional content information which is to be reproduced with the main content information from a plurality of second information recording media on each of which the additional content information is recorded; a notifying device for notifying a managing apparatus which manages the main content information and the additional content information of notice information which indicates the main content information and the additional content information; and a reproducing device for reproducing the main content information and the additional content information,
said computer program making the computer function as at least one portion of said first reading device, said second reading device, said notifying device, and said reproducing device.

16. A recording medium recording thereon a computer program for controlling a computer provided for a managing apparatus for managing main content information, which is recorded on a first information recording medium mounted on an information reproducing apparatus, and additional content information, which is to be reproduced with the main content information and which is recorded on a plurality of second information recording media mounted on said information reproducing apparatus with the first recording medium, said managing apparatus comprising: a notice information recognizing device for recognizing an operation of said information reproducing apparatus which notifies said managing apparatus of notice information which indicates the main content information and the additional content information; and a notice information obtaining device for obtaining the notice information of which said managing apparatus is notified by said information reproducing apparatus,
said computer program making the computer function as at least one portion of said notice information recognizing device and said notice information obtaining device.
